(19) United States
(12) Patent Application Publication
(10) Pub. No.: US 2003/0210524 A1
(43) Pub. Date: Nov. 13, 2003

(54) Computer assembly for facilitating heat dissipation

(76) Inventors: Henry Berg, Menlo Park, CA (US); Ian Blasch, San Francisco, CA (US)

Correspondence Address: HICKMAN PALERMO TRUONG & BECKER, LLP, 1600 WILLOW STREET, SAN JOSE, CA, 95125, US

(21) Appl. No.: 10/388,057

(22) Filed: Mar. 12, 2003

Related U.S. Application Data
(60) Provisional application No. 60/364,157, filed on Mar. 13, 2002.

(51) Int. Cl. G06F 1/20

(52) U.S. Cl. 361/687; 361/709; 361/719

(57) ABSTRACT

A computer assembly is disclosed comprising a heat-generating component, one or more layers of thermally conductive material disposed upon a heat-emanating surface of the component, and a thermally conductive housing portion placed in physical contact with the one or more layers. Such an assembly enables the housing portion to act as a heat sink to effectively draw heat away from the component, and to dissipate that heat. Thus, heat is effectively removed from the component without the use of fans or heat pipes.

### REFERENCE TO OTHER APPLICATIONS

This application claims the benefit of U.S. Provisional Application Serial No. 60/364,157, entitled “Electrical and Mechanical Inventions to Enable the Production of a Small Computer”, filed Mar. 13, 2002, the entire contents of which are incorporated herein by reference.

### FIELD OF THE INVENTION

This invention relates generally to computers, and more particularly to a computer assembly for facilitating heat dissipation.

### BACKGROUND

Many of today's computer components (e.g. processors) generate a relatively large amount of heat during operation. To prevent damage to the components, this heat needs to be drawn away and dissipated. Currently, heat is typically drawn away from components using fans, heat pipes, or both. With a fan, heat is dissipated by way of convection. With a heat pipe, heat is drawn away by conduction. Typically, one end of the heat pipe is coupled to a heat sink, which in turn is coupled to the heat-generating component. The other end of the heat pipe is attached to the chassis of the computer. Through the workings of the fluids within the heat pipe, heat is conducted from the component to the computer chassis. The heat is then dissipated by the chassis.

Fans and heat pipes are effective in some implementations. However, for other implementations, especially those involving small-sized portable computers, they cannot be used. With regard to fans, smaller computers often have no space to accommodate fans. Besides, the use of a fan consumes additional power, which reduces the battery life of the portable computer. With regard to heat pipes, they add cost to the computer. Since low cost is a major selling point for portable computers, the use of heat pipes is often discouraged.

As shown by the above discussion, the current techniques for dissipating heat leave much to be desired. As a result, a need exists for an improved heat dissipation mechanism.

### BRIEF DESCRIPTION OF THE DRAWINGS

FIG. 1 is an exploded perspective view of a computer assembly in accordance with one embodiment of the present invention.

FIG. 2 is a cross sectional view of the computer assembly of FIG. 1 prior to assembly.

FIG. 3 is a cross sectional view of the computer assembly of FIG. 1 after assembly.

FIG. 4 is a cross sectional view of a computer assembly wherein the first housing portion comprises a protrusion.

FIG. 5 is a cross sectional view of the computer assembly of FIG. 4 after assembly.

FIG. 6 is a cross sectional view of a computer assembly wherein a heat sink is thermally coupled and physically attached to the first housing portion.

FIG. 7 is a cross sectional view of the computer assembly of FIG. 6 after assembly.

### DETAILED DESCRIPTION OF EMBODIMENT(S)

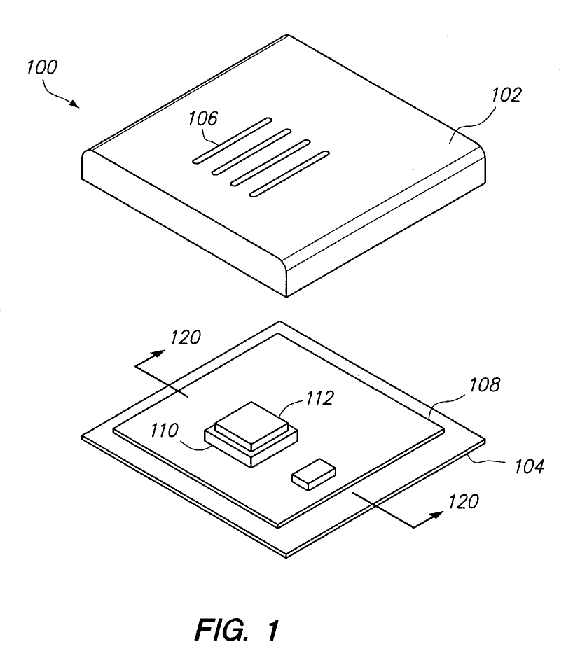

With reference to FIG. 1, there is shown an exploded perspective view of a computer assembly in accordance with one embodiment of the present invention. For the sake of simplicity, only some of the components of the assembly are shown. Other components may be incorporated into the assembly if so desired.

As shown, assembly 100 comprises a first housing portion 102 and a second housing portion 104. In one embodiment, the first housing portion 102 is composed, at least partially, of a thermally conductive material. This enables the first housing portion 102 to be used as a heat sink to draw heat away from a heat-generating component, and to dissipate that heat (as will be discussed in greater detail in a later section). Examples of materials that may be used to construct housing portion 102 include but are not limited to aluminum, magnesium, titanium, and steel. Because housing portion 102 is to be used as a heat sink, some heat-dissipating structures, such as fins 106, may be incorporated into the housing portion 102 to aid it in its heat dissipation function.

In one embodiment, the second housing portion 104 may be composed of any type of material. If so desired, housing portion 104 may be composed of a thermally conductive material to enable it to work with the first housing portion 102 to draw and to dissipate heat. On the other hand, housing portion 104 may be made of a non-thermally conductive material, if so desired.

The second housing portion 104 provides support for a substrate 108 (e.g. a motherboard). This substrate 108 accommodates a plurality of components, including one or more heat-generating components 110. For the sake of simplicity, only one heat-generating component 110 is shown in FIG. 1. For purposes of the present invention, component 110 may be any type of component that generates a substantial amount of heat during operation, such as for example any chip that comprises a processor. Such components usually have a surface, such as the top portion of the chip, from which heat emanates.

Disposed upon this heat-emanating surface is one or more layers 112 of thermally conductive material. These layers 112 may cover all of the heat-emanating surface, or just a portion thereof. For the sake of simplicity, only one layer 112 is shown in FIG. 1. However, it should be noted that any number of layers 112 may be disposed upon the heat-emanating surface. Additional layers may be composed of the same material as layer 112, or they may be composed of different materials. In one embodiment, at least one of the thermally conductive layers 112 is composed of a mechanical shock absorbing material. The significance of this will be discussed in a later section. Examples of materials that may be used for layers 112 include but are not limited to thermal grease, thermal paste, and thermal pads.

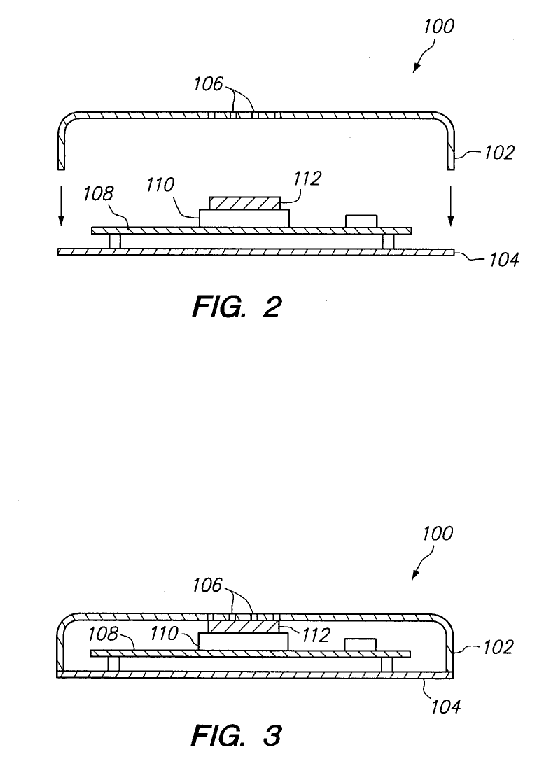

A cross-sectional view of the assembly 100 taken along line 120 is shown in FIG. 2. This view clearly shows the second housing portion 104 supporting the substrate 108, the heat-generating component 110 mounted on the substrate 108, the thermally conductive layer 112 disposed upon the heat-emanating surface of the heat-generating component 110, and the first housing portion 102 placed above the second housing portion 104 prior to assembly.

When the first housing portion 102 is assembled (FIG. 3) with the second housing portion 104 to form an enclosure for the substrate 108, the heat-generating component 112, and the layer 112, the first housing portion 102 is placed in physical contact with the thermally conductive layer 112, as shown. In one embodiment, the first and second housing portions 102, 104 form a snug fit so that after assembly, the first housing portion 102 imposes a small mechanical compression force on the layer 112 and the heat-generating component 110. This force serves to enhance the thermal coupling between the heat-generating component 110 and the first housing portion 102. Because layer 112 is thermally conductive, and because the first housing portion 102 is composed of a thermally conductive material, this assembly enables the first housing portion 102 to act as a heat sink to draw heat away from the heat-generating component 110, and to dissipate that heat. Due to the relatively large surface area of the first housing portion 102, heat will be dissipated by the first housing portion 102 quite effectively. In this manner, heat is effectively removed from the heat-generating component 110 without the use of a fan or a heat pipe.

Because the first housing portion 102 is in physical contact with layer 112 and the heat-generating component 110, mechanical shock applied to the first housing portion 102 may be transferred to the heat-generating component 110. This can cause physical damage to the component 110. To absorb at least some of this mechanical shock, layer 112 in one embodiment is composed of a mechanical shock absorbent material. Examples of materials that both absorb mechanical shock and conduct heat include but are not limited to thermal pads with low durometer such as Chomerics materials A574, G574, and T630. These and other materials may be used. As noted above, additional layers 112 of the same or different materials may be disposed between the component 110 and the first housing portion 102 to provide further shock absorption, if so desired.

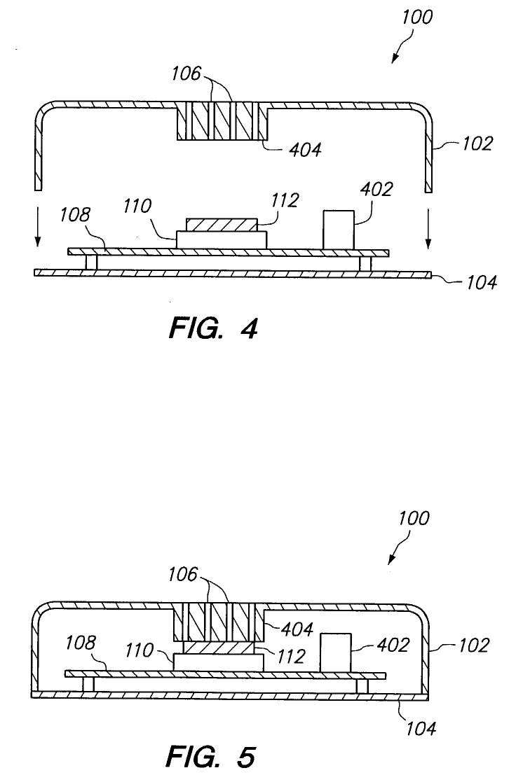

In the embodiment shown in FIGS. 2 and 3, the heat-generating component 110 stands taller than the other components on the substrate 108. Thus, it is a simple matter to place the first housing portion 102 onto the thermally conductive layer 112. In some implementations, however, there may be some components on the substrate 108 that rise above the heat-generating component 110. In such implementations, the first housing portion 102 is augmented with a protrusion to enable the first housing portion 102 to still physically contact the thermally conductive layer 112. This is shown in FIG. 4, wherein another component 402 is depicted as rising above the heat-generating component 110 on the substrate 108. To enable the first housing portion 102 to still have physical contact with layer 112 without contacting component 402, the first housing portion 102 is augmented with a protrusion 404 that extends downward. This protrusion 402 is still an integral part of the first housing portion 102 (and hence, is still composed of a thermally conductive material). It just extends further downward than the rest of the first housing portion 102. Because of this, when the assembly is assembled, the protrusion 402, and hence, the first housing portion 102, is able to achieve physical contact with layer 112 without interfering with component 402, as shown in FIG. 5. As with the embodiment shown in FIGS. 2 and 3, the first housing portion 102 of this embodiment is able to act as a heat sink to draw heat away from the heat-generating component 110, and to dissipate that heat.

Thus far, the embodiments of the present invention have been described as comprising one or more layers 112 of thermally conductive material. While this layer is advantageous for mechanical shock absorption and thermal conduction purposes, it should be noted that it is not required. If so desired, the layer 112 can be removed and the first housing portion 102 can be placed in direct physical contact with the heat-generating component 110. This and other modifications may be made within the scope of the present invention.

### Alternative Embodiment(s)

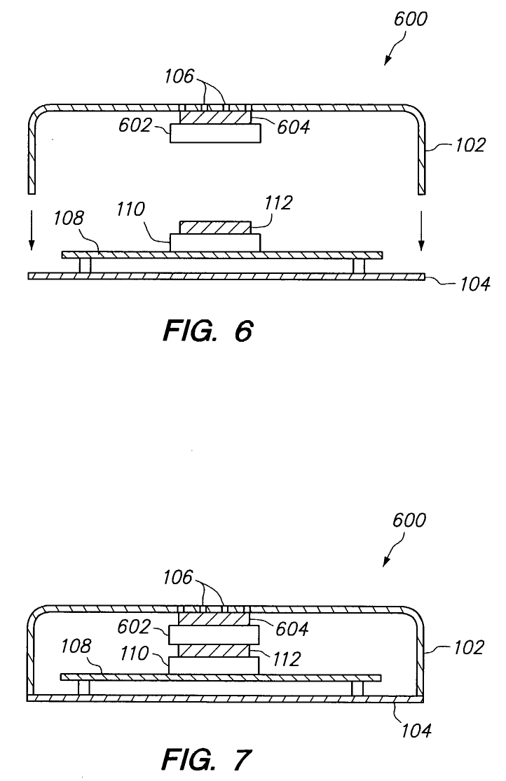

To further enhance the heat dissipating capability of the assembly, a heat sink may be added. A cross sectional view of such an embodiment is shown in FIG. 6. This embodiment comprises many of the same components as the prior embodiments, such as first housing portion 102, second housing portion 104, substrate 108, heat-generating component 110, and thermally conductive layer 112. In addition, this embodiment further comprises a heat sink 602, and one or more thermally conductive layers 604 disposed between the heat sink 602 and the first housing portion 102. In one embodiment, the heat sink 602 is thermally coupled and physically attached to the first housing portion 102. In the embodiment shown in FIG. 6, the heat sink 602 takes the form of a slab or layer of highly, thermally conductive material such as aluminum, copper, silver, or magnesium. Alternatively, heat sink 602 may take on any other form appropriate for a heat sink. All such forms are within the scope of the present invention. In one embodiment, the layer 604 of thermally conductive material may be composed of any material that may be used for layer 112.

When the first housing portion 102 is assembled (FIG. 7) with the second housing portion 104 to form an enclosure for the substrate 108, the heat-generating component 112, layer 112, heat sink 602, and layer 604, a surface of the heat sink 602 is placed in physical contact with the thermally conductive layer 112, as shown. In one embodiment, the first and second housing portions 102, 104 form a snug fit so that after assembly, the first housing portion 102 imposes a small mechanical compression force on the layer 604, the heat sink 602, the layer 112, and the heat-generating component 110. This force serves to enhance the thermal coupling between the heat-generating component 110, the heat sink 602, and the first housing portion 102. Because layer 112, heat sink 602, and layer 604 are all thermally conductive, and because the first housing portion 102 is composed of a thermally conductive material, this assembly enables the first housing portion 102 to work in conjunction with the heat sink 602 to draw heat away from the heat-generating component 110, and to dissipate that heat. With the aid of the heat sink 602, the first housing portion 102 will be able to dissipate heat that much more effectively.

Because the first housing portion 102 is in physical contact with layer 604, heat sink 602, layer 112, and the heat-generating component 110, mechanical shock applied to the first housing portion 102 may be transferred to the heat-generating component 110. This can cause physical damage to the component 110. To absorb at least some of this mechanical shock, at least one of layers 112 and 604, in one embodiment is composed of a mechanical shock absorbent material.

Thus far, the embodiment shown in FIGS. 6 and 7 has been described as comprising one or more layers 112, 604 of thermally conductive material. While these layers are advantageous for mechanical shock absorption and thermal conduction purposes, it should be noted that they are not required. If so desired, the layer 112 can be removed and the surface of the heat sink 602 can be placed in direct physical contact with the heat-emanating surface of the heat-generating component 110. Likewise, the layer 604 can be removed, and the heat sink 602 can be placed in direct physical contact with the first housing portion 102. These and other modifications may be made within the scope of the present invention.

At this point, it should be noted that although the invention has been described with reference to one or more specific embodiments, it should not be construed to be so limited. Various modifications may be made by those of ordinary skill in the art with the benefit of this disclosure without departing from the spirit of the invention. Thus, the invention should not be limited by the specific embodiments used to illustrate it but only by the scope of the issued claims and their equivalents.

What is claimed is:

1. A computer assembly, comprising:
a heat-generating component having a first surface from which heat emanates;
one or more layers of thermally conductive material disposed upon at least a portion of the first surface; and
a first housing portion composed of a thermally conductive material, wherein upon assembly, the first housing portion is placed in physical contact with the one or more layers of thermally conductive material, thereby, enabling the first housing portion to act as a heat sink to draw heat away from the component and to dissipate that heat.

2. The computer assembly of claim 1, wherein after assembly, the first housing portion exerts a mechanical compression force on the one or more layers of thermally conductive material and the component.

3. The computer assembly of claim 2, wherein at least one of the one or more layers of thermally conductive material is composed of a mechanical shock absorbent material which shields the component, at least partially, from shock applied to the first housing portion.

4. The computer assembly of claim 1, wherein the one or more layers of thermally conductive material comprises one or more of the following: thermal pad and thermal grease.

5. The computer assembly of claim 1, wherein the component comprises a processor.

6. The computer assembly of claim 1, further comprising:
a substrate for supporting the component; and
a second housing portion for supporting the substrate;
wherein the first and second housing portions are assembled to form an enclosure for the component, the one or more layers of thermally conductive material, and the substrate.

7. The computer assembly of claim 1, wherein the assembly does not comprise a heat pipe.

8. A computer assembly, comprising:
a heat-generating component having a first surface from which heat emanates; and
a first housing portion composed of a thermally conductive material, wherein upon assembly, the first housing portion is placed in physical contact with the first surface of the component, thereby, enabling the first housing portion to act as a heat sink to draw heat away from the component and to dissipate that heat.

9. The computer assembly of claim 8, wherein after assembly, the first housing portion exerts a mechanical compression force on the component.

10. The computer assembly of claim 8, wherein the component comprises a processor.

11. The computer assembly of claim 8, further comprising:
a substrate for supporting the component; and
a second housing portion for supporting the substrate;
wherein the first and second housing portions are assembled to form an enclosure for the substrate and the component.

12. A computer assembly, comprising:
a heat-generating component having a first surface from which heat emanates;
one or more layers of thermally conductive material disposed upon at least a portion of the first surface;
a first housing portion composed of a thermally conductive material; and
a heat sink thermally coupled and physically attached to the first housing portion, the heat sink having a second surface;
wherein upon assembly, at least a portion of the second surface of the heat sink is placed in physical contact with the one or more layers of thermally conductive material to enable the heat sink and the first housing portion to draw heat away from the component and to dissipate that heat.

13. The computer assembly of claim 12, wherein after assembly, the first housing portion exerts a mechanical compression force on the heat sink, the one or more layers of thermally conductive material and the component.

14. The computer assembly of claim 13, wherein at least one of the one or more layers of thermally conductive material is composed of a mechanical shock absorbent material which shields the component, at least partially, from shock applied to the first housing portion.

15. The computer assembly of claim 12, wherein the one or more layers of thermally conductive material comprises one or more of the following: thermal pad and thermal grease.

16. The computer assembly of claim 12, wherein the component comprises a processor.

17. The computer assembly of claim 12, further comprising:
a substrate for supporting the component; and
a second housing portion for supporting the substrate;
wherein the first and second housing portions are assembled to form an enclosure for the component, the heat sink, the one or more layers of thermally conductive material, and the substrate.

18. The computer assembly of claim 12, further comprising one or more layers of thermally conductive material disposed between the heat sink and the first housing portion.

19. The computer assembly of claim 18, wherein at least one of the one or more layers of thermally conductive material disposed between the heat sink and the first housing portion is composed of a mechanical shock absorbent material.

20. A computer assembly, comprising:
a heat-generating component having a first surface from which heat emanates;
a first housing portion composed of a thermally conductive material; and
a heat sink thermally coupled and physically attached to the first housing portion, the heat sink having a second surface;
wherein upon assembly, at least a portion of the second surface of the heat sink is placed in physical contact with the first surface of the component to enable the heat sink and the first housing portion to draw heat away from the component and to dissipate that heat.

21. The computer assembly of claim 20, wherein after assembly, the first housing portion exerts a mechanical compression force on the heat sink and the component.

22. The computer assembly of claim 20, wherein the component comprises a processor.

23. The computer assembly of claim 20, further comprising:
a substrate for supporting the component; and
a second housing portion for supporting the substrate;
wherein the first and second housing portions are assembled to form an enclosure for the heat sink, the component, and the substrate.

24. The computer assembly of claim 20, further comprising one or more layers of thermally conductive material disposed between the heat sink and the first housing portion.

25. The computer assembly of claim 24, wherein at least one of the one or more layers of thermally conductive material disposed between the heat sink and the first housing portion is composed of a mechanical shock absorbent material.
